(19) United States
(12) Patent Application Publication
(10) Pub. No.: US 2003/0147571 A1
(43) Pub. Date: Aug. 7, 2003

(54) Bearing

(76) Inventor: Ping Chen, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/062,764

(22) Filed: Feb. 5, 2002

(51) Int. Cl. F16C 33/58; F16C 33/02

(52) U.S. Cl. 384/276; 384/516

(57) ABSTRACT

A bearing armed at light duty rotation consists of an outer race (20) and an inner race (10) rotatably contained inside the outer race (20). Multiple annular ribs (13) are formed between the outer race (20) and the inner race (10) to reduce the contact area between the outer race (20) and the inner race (10) to minimize the friction force. Consequently, the bearing has a simple structure and excellent rotating efficiency.

### BACKGROUND OF THE INVENTION

1. Field of the Invention

The present invention relates to a bearing, and more particularly to a bearing with a simplified structure and low product cost.

2. Description of Related Art

A conventional radial bearing is basically composed of an outer race, an inner race, a retainer and multiple ball or roller bearings. The outer race receives the inner race inside and then secures the retainer between the outer race and the inner race. The multiple balls are rotatably held within the retainer between the races to reduce friction between and abrasion of the races when the radial bearing rotates.

Presently, such conventional radial bearings are usually made of metal and have a high precision structure to achieve extremely small friction coefficients. With the high precision and extremely small friction coefficients, the bearings are suitable for use in precision machinery with high rotational speeds. However, expendable goods only needing light duty bearing should be convenient to assemble and have low product cost first. The conventional radial bearing does not meet these criteria.

Toward this objective, the bearing in accordance with the present invention provides a simplified bearing device with a low product cost and excellent efficiency, to satisfy the requirement of expendable goods

### SUMMARY OF THE INVENTION

The main objective of the invention is to provide a bearing that has a simple structure and low product cost.

Other advantages and novel features of the invention will become more apparent from the following detailed description when taken in conjunction with the accompanying drawings.

### BRIEF DESCRIPTION OF THE DRAWINGS

FIG. 1 is an exploded perspective view of a bearing in accordance with the present invention;

FIG. 2 is a cross sectional side plan view of the bearing in FIG. 1;

FIG. 3 is an enlarged cross sectional partial side plan view of the bearing in FIG. 2;

FIG. 4 is an exploded perspective view of another embodiment of the bearing in accordance with the present invention; and

FIG. 5 is an enlarged cross sectional partial side plan view of the embodiment of the bearing in FIG. 4.

### DETAILED DESCRIPTION OF THE PREFERRED EMBODIMENT

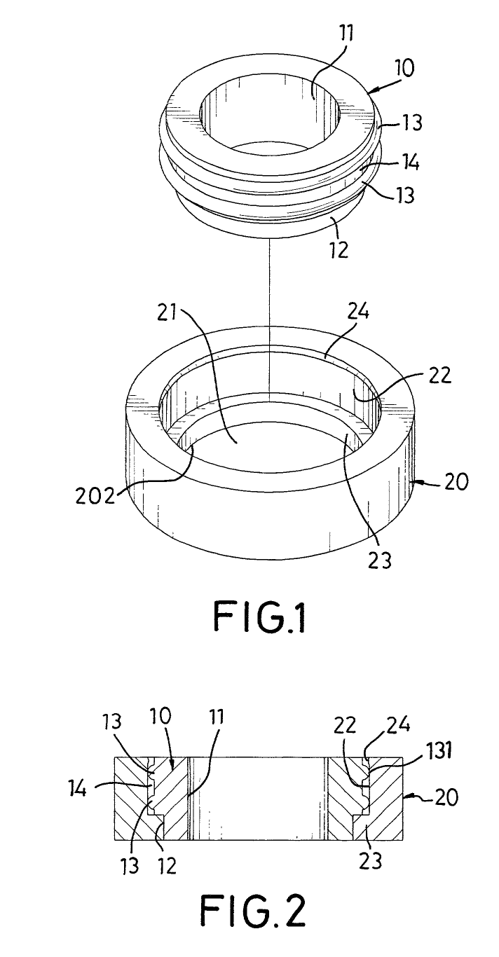

With reference to FIGS. 1 and 2, a bearing accordance with the present invention is adapted to used in a light duty expandable goods in and made of plastic and comprises an inner race (10) and an outer race (20) mounted around the inner race (10).

The inner race (10) is an annular ring with a center and has a shaft insertion hole (11) defined in the center of the inner race (10) to be mounted around a shaft (not show) of an object to which the bearing is attached. An annular notch (12) is defined around an outer periphery of the inner race (10) at an edge toward the outer race (20). Two annular ribs (13) are formed around the outer periphery of the inner race (10) in parallel, and a groove (14) is formed between the ribs (13). Each rib (13) has a smooth outer peak (131).

The outer race (20) is an annular ring and has a longitudinal through hole (21) with a bottom (not numbered) and a top (not numbered) defined in the outer race (20) through which the inner race (10) is inserted. An opening (202) is defined in the bottom of the longitudinal through hole (21), and a shoulder (23) is formed around the opening (202) to engage the annular notch (12) around the inner race (10). An inner side periphery (22) of the longitudinal through hole (21) extends from the top of the outer race (20) to the shoulder (23). Additionally, a small lip (24) protrudes inward around the top of the inner side periphery (22) so that the inner race (10) can be pressed into and then longitudinally locked inside the longitudinal through hole (21) such that the inner race (10) can rotate inside the outer race (20). When the inner race (10) is assembled in the outer race (20), only the outer peak (131) of each rib (13) contacts the inner side periphery (22) of the longitudinal through hole (21). Thus the friction force between the inner race (10) and the outer race (20) is reduced because the contacting surface of the outer peak (131) between the races (10, 20) is smooth.

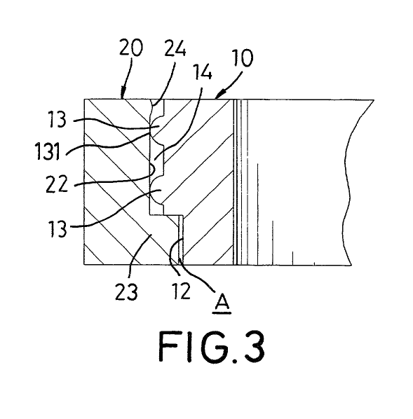

With reference to FIG. 3, the annular notch (12) has a diameter that is slightly larger than the diameter of the shoulder (23) so a gap (A) is formed between the outer periphery of the inner race (10) within the notch (12) and the shoulder (23) of the outer race (20). Furthermore, lubricating materials such as wax or lubrication oils are applied in the groove (14) to make the rotation of the bearing device fluent and reduce the friction damage and noise.

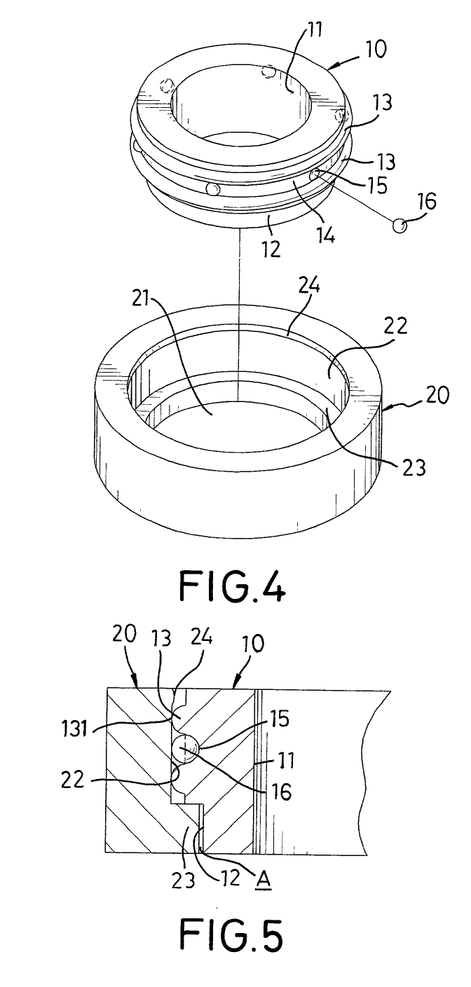

With reference to FIGS. 4 and 5, the groove (14) around the inner race (10) further has multiple rollers (16) embedded inside to further reduce the friction force.

The bearing in accordance with the present invention has a simplified structure as described. Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A bearing taking light duty of rotation and comprising:
an inner race (10) with an outer periphery having a shaft insertion hole (11) defined longitudinally through the inner race (10) and an annular notch (12) defined around the outer periphery of the inner race (10);
an outer race (20) for receiving the inner race (20) and having
a longitudinal through hole (21) with a bottom, an inner side periphery (22), and a top defined in the outer race (20);
an opening (202) defined in the bottom of the longitudinal through hole (21); and
a shoulder (23) formed around the opening (202) to engage with the annular notch (12) around the inner race (10);
wherein at least one rib (13) is formed between the outer periphery of the inner race (10) and the inner side periphery (22) of the outer race (20).

2. The bearing as claimed in claim 1, wherein the inner race (10) is plastic and has the at least one annular rib (13) formed around the outer periphery and each rib (13) has a smooth outer peak (131) to make the bearing have small friction; and
the outer race (20) is plastic.

3. The bearing as claimed in claim 1, wherein the inner race (10) is plastic; and
the outer race (20) is plastic and has the at least one annular rib (13) formed on the inner side periphery (22) and each rib (13) has a smooth outer peak (131) to make the bearing have small friction.

4. The bearing as claimed in claim 1, wherein the outer race (20) further has a lip (24) protruding radially inward around the top of the longitudinal through hole (21) to lock the inner race (10) inside the longitudinal through hole (21).

5. The bearing as claimed in claim 2, wherein the outer race (20) further has a lip (24) protruding radially inward around the top of the longitudinal through hole (21) to lock the inner race (10) inside the longitudinal through hole (21).

6. The bearing as claimed in claim 3, wherein the outer race (20) further has a lip (24) protruding radially inward around the top of the longitudinal through hole (21) to lock the inner race (10) inside the longitudinal through hole (21).

7. The bearing as claimed in claim 1, wherein two parallel annular ribs (13) are formed between the outer periphery of the inner race (10) and the inner side periphery (20) of the outer race (20), and a groove (14) is formed between the two ribs (13).

8. The bearing as claimed in claim 7, wherein the groove (14) further has multiple rollers (16) rotatably embedded inside.

9. The bearing as claimed in claim 7, wherein the groove (14) is filled with lubricating material to reduce the friction force between the inner race (10) and the outer race (20).

10. The bearing as claimed in claim 8, wherein the groove (14) is filled with lubricating material to reduce the friction force between the inner race (10) and the outer race (20).
